(19) United States
(12) Patent Application Publication
(10) Pub. No.: US 2026/0338611 A1
(43) Pub. Date: Oct. 29, 2026

(54) SEASONING LIQUID TEMPERATURE MEASUREMENT DEVICE AND SEASONING LIQUID SUPPLY APPARATUS

(71) Applicant: ICHIRAN INC., Fukuoka (JP)

(72) Inventors: Ryusuke SOBUE, Fukuoka (JP); Yasutaka MIZUTANI, Fukuoka (JP)

(21) Appl. No.: 19/113,512

(22) PCT Filed: Feb. 9, 2023
(86) PCT No.: PCT/JP2023/004443

§ 371 Date: Mar. 20, 2025

(51) Int. Cl. G01K 1/14; A47J 36/24; A47J 36/34; G01K 13/02; G05D 7/06; G05D 23/22

(52) U.S. Cl. CPC G01K 1/146; A47J 36/2483; A47J 36/34; G01K 13/026; G05D 7/0635; G05D 23/22; A47J 2202/00

(57) ABSTRACT

Provided are a seasoning liquid temperature measurement device and a seasoning liquid supply apparatus that are capable of supplying a suitable volume of a seasoning liquid reserved and heated in a reserve tank to a container accommodating a food and drink product at a suitable temperature. The seasoning liquid temperature measurement device (1) for measuring the temperature of the seasoning liquid reserved and heated in the reserve tank (7) includes a temperature sensor (11) disposed inside the reserve tank and measuring the temperature of the seasoning liquid reserved in the reserve tank, a holder (12) holding the temperature sensor, and a position adjustment unit (15) enabling adjustment of the position of the temperature sensor relative to the reserve tank.

### TECHNICAL FIELD

The present invention relates to a seasoning liquid temperature measurement device and a seasoning liquid supply apparatus.

### BACKGROUND ART

The introduction of cooking robots performing cooking, serving, and the like of food and drink products is being advanced in eating and drinking establishments and the like, against the backdrop of a decreasing working population. The applicant of the present application has devised an invention related to an apparatus supplying soup of ramen (Chinese-style Japanese noodle soup) or the like from a stockpot in which the soup is reserved to a bowl to be served to a customer (see PTL 1).

Ramen is composed of ingredients such as noodles and a seasoning liquid such as soup. Tastiness of ramen depends on the temperature and the volume of the seasoning liquid. Thus, an apparatus supplying a seasoning liquid from a stockpot in which the seasoning liquid is reserved to a bowl needs to control the temperature and the volume of the seasoning liquid to be supplied to the bowl with high precision by using a temperature sensor, a flow sensor, and the like. When the seasoning liquid inside the stockpot is heated and air bubbles are generated, inaccuracies in flow rate measurement results by a flow sensor are caused. As a result, the temperature and the volume of the seasoning liquid to be supplied to the bowl deviate from target values, and the taste of the ramen is not what is desired.

Inventions related to a cooking device including a temperature sensor have been proposed in the past (for example, see PTL 2).

### CITATION LIST

### Patent Literature

[PTL 1] WO2022/102107A1

[PTL 2] JP2005-116348A

### SUMMARY OF INVENTION

### Technical Problem

The present invention is directed to providing a seasoning liquid temperature measurement device and a seasoning liquid supply apparatus that are capable of supplying a suitable volume of a seasoning liquid reserved and heated in a reserve tank to a container accommodating a food and drink product at a suitable temperature.

### Solution to Problem

A seasoning liquid temperature measurement device according to one aspect of the present invention is a device for measuring the temperature of a seasoning liquid reserved and heated in a reserve tank, the temperature measurement device including a temperature sensor that is disposed inside the reserve tank and measures the temperature of the seasoning liquid reserved in the reserve tank, a holder that holds the temperature sensor, and a position adjustment unit that enables adjustment of the position of the temperature sensor relative to the reserve tank.

### Advantageous Effects of Invention

The present invention is able to supply a suitable volume of a seasoning liquid reserved and heated in a reserve tank to a container accommodating a food and drink product at a suitable temperature.

### BRIEF DESCRIPTION OF DRAWINGS

FIG. 1 is a functional block diagram illustrating an embodiment of a seasoning liquid supply apparatus according to the present invention.

FIG. 2 is a schematic diagram illustrating a seasoning liquid supply line provided by the supply apparatus.

FIG. 3 is a perspective view of the supply apparatus.

FIG. 4 is a schematic diagram illustrating a positional relation inside a reserve tank between a temperature sensor and a suction pipe that are included in the supply apparatus.

FIG. 5 is a schematic diagram illustrating a slope of a blocking plate included in the supply apparatus.

FIG. 6 is a perspective view of the supply apparatus illustrating a state with a holder included in the supply apparatus moved upward.

FIG. 7 is a perspective view of the supply apparatus illustrating another embodiment of the supply apparatus.

FIG. 8 is a schematic diagram illustrating attachment locations of a position adjustment unit in a housing included in the supply apparatus.

FIG. 9 is a perspective view of the supply apparatus illustrating yet another embodiment of the supply apparatus.

### DESCRIPTION OF EMBODIMENTS

An embodiment of a seasoning liquid temperature measurement device and a seasoning liquid supply apparatus according to the present invention will now be described below together with the drawings.

A temperature measurement device for measuring the temperature of ramen soup reserved and heated in a stockpot and a supply apparatus for supplying the soup reserved in the stockpot from the stockpot to a bowl in which ramen is accommodated are used in the following description. Specifically, the temperature measurement device and the supply apparatus are installed in a kitchen in a ramen shop. Ramen is an example of a food and drink product in the present invention. Ramen soup is an example of a seasoning liquid in the present invention. A stockpot is an example of a reserve tank in which the seasoning liquid in the present invention is reserved. A bowl is an example of a container for accommodating a food and drink product.

Note that the seasoning liquid in the present invention is not limited to ramen soup.

### Configurations of Seasoning Liquid Supply Apparatus and Temperature Measurement Device (1)

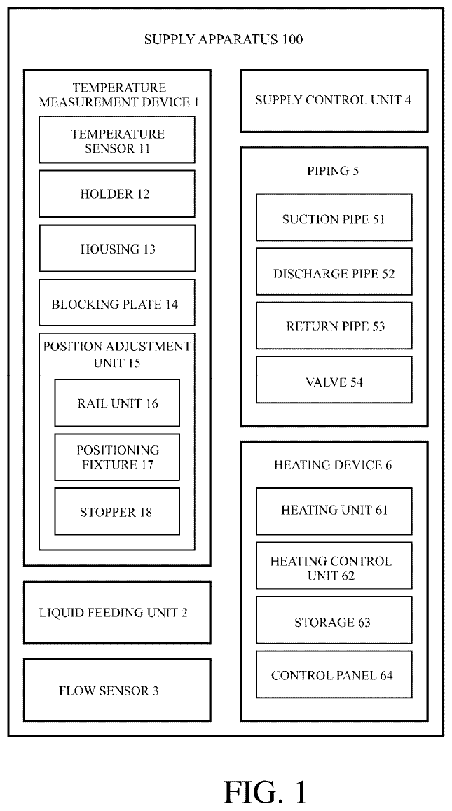

FIG. 1 is a functional block diagram illustrating an embodiment of the seasoning liquid supply apparatus and the temperature measurement device according to the present invention.

The supply apparatus 100 (hereinafter referred to as the “apparatus 100”) is an example of the seasoning liquid supply apparatus according to the present invention. The apparatus 100 supplies a predetermined volume of soup reserved in a stockpot to a bowl at a predetermined timing.

Herein, the apparatus 100 supplies soup from the stockpot to a bowl, based on a control signal from a control system (unillustrated) installed in a ramen shop. In other words, a timing at which the apparatus 100 supplies the soup to a bowl is determined by the control system. For example, the control system accepts order information from a customer and controls the operation of the apparatus 100, based on the order information.

The apparatus 100 includes a temperature measurement device 1, a liquid feeding unit 2, a flow sensor 3, a supply control unit 4, piping 5, and a heating device 6.

The temperature measurement device 1 (hereinafter referred to as the “device 1”) included in the apparatus 100 is an example of the seasoning liquid temperature measurement device according to the present invention.

The device 1 measures the temperature of soup reserved and heated in the stockpot. The measured temperature is used for heat control of the soup in the stockpot.

The liquid feeding unit 2 feeds the soup reserved in the stockpot from the stockpot to a bowl. The liquid feeding unit 2 is a tubing pump.

The flow sensor 3 measures the flow rate of soup to be fed from the stockpot to a bowl. The flow sensor 3 is a Coriolis flowmeter.

Note that the flow sensor in the present invention may be an ultrasonic flowmeter.

The supply control unit 4 controls supply of soup from the stockpot to a bowl, based on the flow rate measured by the flow sensor 3. The supply control unit 4 controls supply of soup from the stockpot to a bowl by controlling opening and closing of a valve 54 to be described later, based on the flow rate measured by the flow sensor 3. The supply control unit 4 is implemented by a control program operating on a programmable logic controller (PLC).

Note that the supply control unit in the present invention is not limited to the control program operating on the PLC. Specifically, it is sufficient as long as the supply control unit is capable of implementing control of opening and closing of the valve 54 to be described later and may be implemented by, for example, a control program operating on a microcomputer or a field programmable gate array (FPGA).

The Soup to be supplied from the stockpot to a bowl passes through the piping 5. The piping 5 includes a suction pipe 51, a discharge pipe 52, a return pipe 53, and the valve 54.

The suction pipe 51 is a pipe through which the soup in the stockpot to be sucked up by the liquid feeding unit 2 passes. One end of the suction pipe 51 is disposed in the stockpot. The other end of the suction pipe 51 is connected to the valve 54. The flow rate of the soup passing through the suction pipe 51 is measured by the flow sensor 3.

The discharge pipe 52 is a pipe through which the soup passes after passing through the valve 54. One end of the discharge pipe 52 is connected to the valve 54. The other end of the discharge pipe 52 is disposed in proximity to a bowl. The soup passing through the discharge pipe 52 is supplied to the bowl.

The return pipe 53 is a pipe through which the soup that does not passing through the valve 54, among the soup passing through the suction pipe 51, passes. One end of the return pipe 53 is connected to the valve 54. The other end of the return pipe 53 is disposed in the stockpot. The soup passing through the return pipe 53 is supplied (returned) to the stockpot.

The valve 54 switches the connection between the suction pipe 51 and either the discharge pipe 52 or the return pipe 53. Specifically, the valve 54 switches the connection between the suction pipe 51 and the discharge pipe 52, or the connection between the suction pipe 51 and the return pipe 53. The valve 54 is a pinch valve.

The heating device 6 heats the soup reserved in the stockpot. The heating device 6 is an induction heating (IH) heater. The heating device 6 includes a heating unit 61, a heating control unit 62, a storage 63, and a control panel 64.

The heating unit 61 induction-heats the soup reserved in the stockpot. The heating unit 61 includes a heating coil that heats the bottom surface of the stockpot (made of metal) being a magnetic body. Specifically, the soup reserved in the stockpot is heated by the bottom surface of the stockpot being heated by the heating coil.

The heating control unit 62 controls the heating output of the heating unit 61 in such a way that the temperature of the soup reserved in the stockpot converges to a predetermined temperature (a target temperature: for example, 95 °C) without exceeding a predetermined temperature (an upper temperature limit: for example, 100 °C). In other words, the heating control unit 62 controls (PID controls) supply of current to the heating coil by the heating unit 61. Specifically, the heating control unit 62 determines whether to supply current to the heating coil, the current value of supplied current, and the like. The heating control unit 62 is implemented by a computer program operating on a microcomputer. The heating control unit 62 controls the heating output of the heating unit 61, based on a temperature measured by the device 1, the target temperature stored in the storage 63, an adjustment parameter of the PID control, and the like.

For example, the target temperature is set by a user, based on the boiling point of the soup, the type of the soup, the volume of the soup reserved in the stockpot, changes in the room temperature in a kitchen where the apparatus 100 is installed, and the like. The target temperature is lower than the boiling point (the upper temperature limit) of the soup.

The temperature of the soup reserved in the stockpot converges to the target temperature by the PID control performed by the heating control unit 62. For example, the manner in which the temperature of the soup reserved in the stockpot converges to the target temperature is a manner of converging to the target temperature without exceeding the target temperature (without a so-called overshoot) or a manner of converging to the target temperature without exceeding the upper temperature limit even when exceeding the target temperature.

The storage 63 stores information required for the operation of the heating device 6. The information to be stored in the storage 63 includes the target temperature and an adjustment parameter of the PID control performed by the heating control unit 62.

Note that examples of the storage in the present invention include portable storage media such as hard disk drives (HDD), solid-state drives (SSD), and flash memory, and other non-transitory storage media, as well as random access memory (RAM) and other transitory storage media.

The control panel 64 accepts operation information required for the operation of the heating device 6 from a user (a clerk in the ramen shop) of the apparatus 100. The user operates the apparatus 100 by operating the control panel 64. For example, when the user wants to change the target temperature stored in the storage 63, the user inputs a new target temperature value from the control panel 64. The control panel 64 is configured with a touch panel.

### Configuration of Seasoning Liquid Temperature Measurement Device

The device 1 includes a temperature sensor 11, a holder 12, a housing 13, a blocking plate 14, and a position adjustment unit 15.

The temperature sensor 11 is disposed inside the stockpot and measures the temperature of the soup reserved in the stockpot. The temperature sensor 11 is a sheath thermocouple including a pair of thermocouple wires accommodated in a metal sheath (for example, a type K thermocouple or a type T thermocouple).

The holder 12 holds the temperature sensor 11. Details of the configuration of the holder 12 will be described later.

The housing 13 accommodates the heating device 6 that heats the soup reserved in the stockpot.

The blocking plate 14 is disposed above the stockpot. Details of the blocking plate 14 will be described later.

The position adjustment unit 15 enables adjustment of the position of the temperature sensor 11 relative to the stockpot. The position adjustment unit 15 includes a rail unit 16, a positioning fixture 17, and stoppers 18.

The rail unit 16 (for example, the aluminum frame Type FSL-L manufactured by Sugatsune Kogyo Co., Ltd.) moves the holder 12 to allow the temperature sensor 11 to move in and out between the interior and exterior of the reserve tank.

The positioning fixture 17 (for example, the adjustable mount FSL-V36 manufactured by Sugatsune Kogyo Co., Ltd.) fixes the position of the holder 12 relative to the rail unit 16. The positioning fixture 17 includes a sliding unit disposed in a rail of the rail unit 16 and a restriction operation unit for controlling the movement restriction of the sliding unit in the rail. When the user operates the restriction operation unit to allow the sliding unit to move within the rail, the positioning fixture 17 is allowed to move along the rail of the rail unit 16. When the user operates the restriction operation unit and the sliding unit is not allowed to move within the rail, the positioning fixture 17 is not allowed to move along the rail of the rail unit 16.

Herein, the positioning fixture 17 is coupled with the holder 12. In other words, when the restriction operation unit of the positioning fixture 17 is operated and the positioning fixture 17 moves along the rail of the rail unit 16, the holder also moves along the rail of the rail unit 16. As described above, the holder 12 holds the temperature sensor 11. In other words, when the restriction operation unit of the positioning fixture 17 is operated and the positioning fixture 17 moves along the rail of the rail unit 16, the temperature sensor 11 also moves along the rail of the rail unit 16.

The stoppers 18 (for example, the stopper FSL-S4 manufactured by Sugatsune Kogyo Co., Ltd.) are each disposed in the rail of the rail unit 16 in such a way as to allow the sliding unit of the positioning fixture 17 to abut on each stopper 18. The stoppers 18 are disposed at both ends of the rail, one at each end. In other words, the stoppers 18 define the range of movement of the positioning fixture 17 that is movable along the rail.

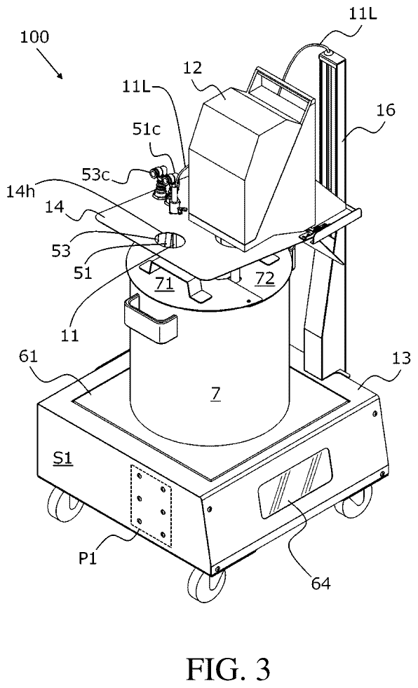

Herein, the moving direction of the positioning fixture 17 that is movable along the rail of the rail unit 16 is the vertical direction (the vertical direction of the page in FIG. 3 to be described later). Specifically, the stopper 18 disposed at one end (the upper end) of the rail defines an upper limit position of the positioning fixture 17, and the stopper 18 disposed at the other end (the lower end) of the rail defines a lower limit position of the positioning fixture 17. That is, the stoppers 18 define the upper limit positions and lower limit positions of the temperature sensor 11 and the suction pipe 51 that are coupled with the positioning fixture 17. In other words, a user can determine the vertical positions of the temperature sensor 11 and the suction pipe 51 that are coupled with the positioning fixture 17 to predetermined positions by moving the positioning fixture 17 until the positioning fixture 17 abuts on each stopper 18.

Note that the stopper 18 disposed at the upper end of the rail in the following description is an end cap of the rail (for example, the end cap FSL-EC manufactured by Sugatsune Kogyo Co., Ltd.).

### Supply Line of Seasoning Liquid Supply Apparatus

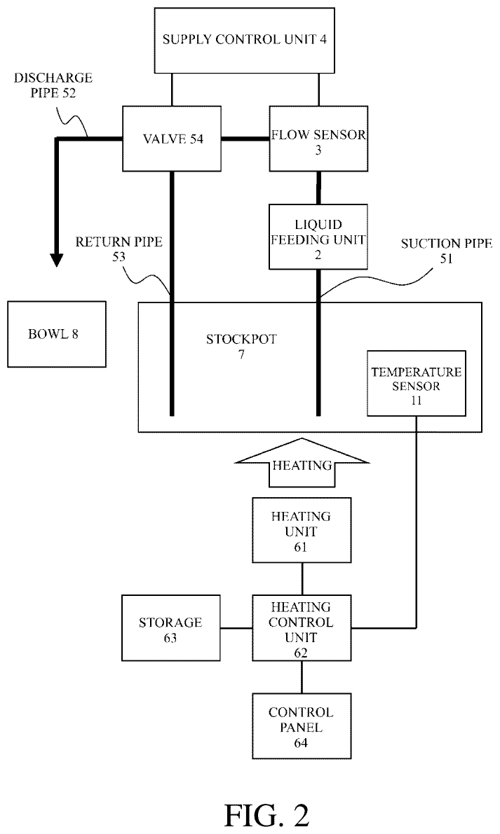

FIG. 2 is a schematic diagram illustrating a soup supply line provided by the apparatus 100. The figure illustrates that the soup reserved in a stockpot 7 is sucked in by the liquid feeding unit 2, passes through the suction pipe 51, the valve 54, and the discharge pipe 52, and is supplied to a bowl 8.

The figure illustrates that the flow sensor 3 measures the flow rate of soup passing through the suction pipe 51, and the measurement result (a signal indicating the flow rate) is output to the supply control unit 4. The figure illustrates that the supply control unit 4 controls opening and closing of the valve 54, based on the flow rate measured by the flow sensor 3. When the valve 54 opens, the soup from the suction pipe 51 passes through the discharge pipe 52. When the valve 54 is closed, the soup from the suction pipe 51 passes through the return pipe 53 and returns to the stockpot 7.

The figure illustrates that the measurement result of the temperature (a signal indicating the temperature) of the soup reserved in the stockpot 7 measured by the temperature sensor 11 is output to the heating control unit 62. The figure illustrates that the heating control unit 62 controls the heating output of the heating unit 61, based on the measurement result from the temperature sensor 11, the information stored in the storage 63 (the upper temperature limit and the target temperature), and the like. The figure illustrates that the heating unit 61 heats the soup inside the stockpot 7 by heating the outside of the bottom portion (the bottom surface) of the stockpot 7.

Herein, the upper temperature limit is the boiling point of the soup. The target temperature is a temperature lower than the upper temperature limit and is a temperature at which ramen to be accommodated in a bowl and to be provided to a customer has a desired taste.

The heating control unit 62 controls the heating output of the heating unit 61 in such a way that the temperature of the soup in the stockpot 7 does not exceed the upper temperature limit, based on changes in the temperature of the soup in the stockpot 7 measured by the temperature sensor 11 and stored in the storage 63. As will be described later, the temperature sensor 11 measures the temperature at a position with the highest temperature in the stockpot 7. Specifically, the heating control unit 62 achieves the heating of the soup in the stockpot 7 in such a way as to prevent the soup in the stockpot 7 from boiling and generating air bubbles. As a result, the flow sensor 3 can measure an accurate flow rate.

The heating control unit 62 controls the heating output of the heating unit 61 in such a way that the temperature of the soup in the stockpot 7 reaches the target temperature, based on changes in the temperature of the soup in the stockpot 7 measured by the temperature sensor 11 and stored in the storage 63. Specifically, the heating control unit 62 increases the heating output of the heating unit 61 in such a way that the temperature of the soup in the stockpot 7 rises, when the temperature measured by the temperature sensor 11 is lower than the target temperature. In contrast, the heating control unit 62 decreases the heating output of the heating unit 61 in such a way that the temperature of the soup in the stockpot 7 drops or the rising speed of the temperature slows down, when the temperature measured by the temperature sensor 11 is higher than the target temperature or when the temperature measured by the temperature sensor 11 is expected to become higher than the target temperature if the heating is continued at the current heating output of the heating unit 61.

In this way, the heating control unit 62 controls the heating output of the heating unit 61 in such a way that the temperature of the soup in the stockpot 7 converges to the target temperature without exceeding the upper temperature limit even in the presence of factors that cause fluctuations in the temperature of the soup in the stockpot 7, such as the ambient temperature in a kitchen where the stockpot 7 is disposed and replenishment of soup in the stockpot 7.

### Usage Example of Seasoning Liquid Supply Apparatus

FIG. 3 is a perspective view of the apparatus 100.

The figure illustrates that the stockpot 7 is disposed on the heating unit 61 in the heating device 6 accommodated in the housing 13. The housing 13 includes unillustrated heat-resistant glass [for example, FireLite (registered trademark) manufactured by Nippon Electric Glass Co., Ltd.] covering the surface of the heating unit 61. The bottom surface of the stockpot 7 is placed on the surface of the heat-resistant glass.

The figure illustrates that the blocking plate 14 includes a hole 14h. The hole 14h is a hole allowing replenishment of the soup in the stockpot 7 for replenishment while the stockpot 7 is placed on the apparatus 100. Specifically, a user removes, from the stockpot 7, a lid (a lid 71, one of the two parts, the lid 71 and a lid 72, that make up the lid) covering an opening of the stockpot 7. The hole 14h is positioned above part of the opening of the stockpot 7 from which the lid 71 is removed. Then, the user inserts a funnel into the hole 14h. The funnel is disposed in the hole 14h. Then, the user pours soup for replenishment (reserved in a stockpot for replenishment) into the funnel placed into the hole 14h from above the funnel. The soup for replenishment poured into the funnel passes through the funnel and the opening of the stockpot 7 and is supplied into the stockpot 7. Then, when the replenishment of soup is completed, the user covers the opening of the stockpot 7 with the lid 71 and removes the funnel from the hole 14h.

Note that the blocking plate in the present invention does not need to include a hole into which the funnel is placed. In this case, for example, a user removes the lid 71 from the opening of the stockpot 7 and directly pours soup for replenishment into the stockpot 7 from part of the opening of the stockpot 7 previously covered by the lid 71.

The figure illustrates that a joint 51C and a joint 53C are disposed on the blocking plate 14. The joint 51C constitutes part of the suction pipe 51. One end of the suction pipe 51 disposed inside the stockpot 7 is connected to the joint 51C. One end of the suction pipe (unillustrated) coupled with the liquid feeding unit 2 accommodated in the holder 12 is connected to the joint 51C. The joint 53C constitutes part of the return pipe 53. One end of the return pipe 53 disposed inside the stockpot 7 is connected to the joint 53C. One end the return pipe (unillustrated) connected to the valve 54 is connected to the joint 53C.

The figure illustrates that a signal line 11L is placed into the rail unit 16. The signal line 11L transmits, to the heating control unit 62, a signal based on the temperature of the soup reserved in the stockpot 7 measured by the temperature sensor 11. One end of the signal line 11L is connected to the temperature sensor 11 disposed inside the stockpot 7. The other end of the signal line 11L is connected to the heating control unit 62 accommodated in the housing 13. Specifically, the temperature of the soup reserved inside the stockpot 7 is measured based on the magnitude of a thermoelectromotive force generated depending on the temperature difference (T1-T2) between the temperature (T1) on one end side of the signal line 11L disposed inside the stockpot 7 and the temperature (T2) on the other end side of the signal line 11L connected to the heating control unit 62.

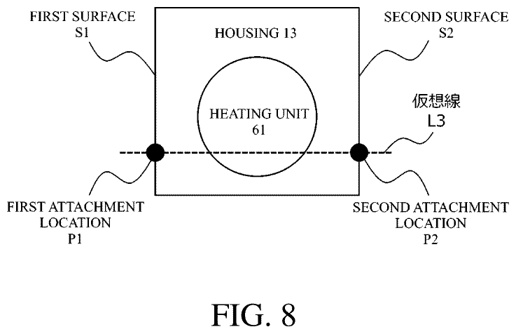

The figure illustrates that an attachment location P1 (a region enclosed by broken lines in the figure) is disposed on a side surface S1 of the housing 13. The attachment location P1 is a location where the rail unit 16 is attached to the housing 13. The figure illustrates that six bolts for attaching the rail unit 16 to the housing 13 are disposed at the attachment location P1 on the side surface S1. The housing 13 includes two locations as locations where the rail unit 16 is attached. The attachment location P1 is a first attachment location in the present invention. A user selects either one of the two locations (P1 and P2) on the housing 13 as a location where the rail unit 16 is attached, based on the layout of a kitchen where the apparatus 100 is installed (including the orientation and the shape of equipment in the kitchen, a line of flow of a clerk in the kitchen) and the like. Note that the figure illustrates the case of the rail unit 16 attached to a second attachment location (P2 in FIG. 8) on the housing 13.

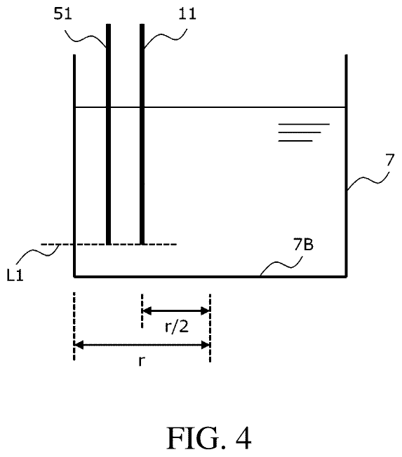

FIG. 4 is a schematic diagram illustrating a positional relation inside the stockpot 7 between a temperature measurement unit in the temperature sensor 11 and a suction port of the suction pipe 51.

The figure illustrates that the positions of the lower ends of the temperature sensor 11 and the suction pipe 51 in the height direction (the vertical direction of the page) match at a position indicated by a broken line L1. The temperature sensor 11 performs temperature measurement in proximity to the lower end of the temperature sensor 11. In other words, the temperature measurement unit in the temperature sensor 11 is disposed at the lower end of the temperature sensor 11. The suction pipe 51 sucks in the soup from the lower end of the suction pipe 51. In other words, the suction port of the suction pipe 51 is disposed at the lower end of the suction pipe 51.

The temperature of the soup reserved in the stockpot 7 increases as the soup becomes closer to the bottom surface 7B of the stockpot 7 close to the heating unit 61. In other words, the temperature sensor 11 measures a temperature close to the temperature of the soup, which is sucked by the suction pipe 51 and supplied to a bowl, among the soup reserved in the stockpot 7.

Herein, as described above, the positions of the temperature sensor 11 and the suction pipe 51 in the vertical direction (the vertical direction of the page in FIG. 3) can be defined by the position adjustment unit 15 operated by a user. Specifically, when the soup reserved in the stockpot 7 is heated in such a way that the soup can be supplied to a bowl 8, the user moves the positioning fixture 17 downward and fixes the position of the positioning fixture 17 relative to the rail unit 16 by operating the positioning fixture 17 until the positioning fixture 17 abuts on the stopper 18 disposed at the lower end of the rail unit 16. As a result, the positions of the lower ends of the temperature sensor 11 and the suction pipe 51 are defined in proximity to the inner surface of the bottom surface 7B of the stockpot 7 (the inner surface of the stockpot 7) with the highest temperature inside the stockpot 7 (for example, 5 mm above the inner surface of the bottom surface 7B).

The figure illustrates that the temperature sensor 11 is disposed at a midway position of the radius r of the bottom surface 7B of the bottomed cylindrical stockpot 7 (a position at a distance of r/2 from the center point of the bottom surface 7B). The position of the temperature sensor 11 in the radial direction of the bottom surface 7B is defined by the position adjustment unit 15, similarly to the aforementioned vertical position of the temperature sensor 11. In other words, the temperature sensor 11 is attached to the blocking plate 14 in such a way that the position of the temperature sensor 11 is defined at a predetermined position in the radial direction of the bottom surface 7B.

Herein, the midway position of the radius r of the bottom surface 7B is a position with the highest temperature inside the stockpot 7. The position with the highest temperature inside the stockpot 7 in the radial direction of the bottom surface 7B is determined based on the configuration of the heating unit 61 (such as the disposition of the coil), the position of the stockpot 7 placed on the heating unit 61, and the like.

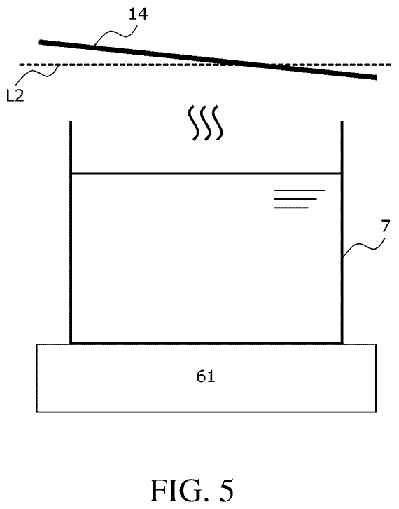

FIG. 5 is a schematic diagram illustrating the slope of the blocking plate 14. The figure illustrates that the blocking plate 14 is obliquely disposed relative to the horizontal direction (a direction indicated by a broken line L2 in the figure). When the temperature sensor 11 is disposed inside the stockpot 7, the blocking plate 14 is disposed above the stockpot 7. Part of the soup reserved in the stockpot 7 is heated by the heating unit 61 and becomes vapor. The vapor rises toward the upper part of the stockpot 7 and hits the back side of the blocking plate 14 (a surface on the lower side of the page). The vapor hitting the blocking plate 14 becomes condensate. Since the blocking plate 14 is obliquely disposed relative to the horizontal direction, the condensate moves along the bottom surface of the blocking plate 14 (toward the righthand side of the page) and drops to the outside of the stockpot 7.

In this way, when the vapor of the soup in the stockpot 7 hits the blocking plate 14 and condenses, the blocking plate 14 does not allow the condensate to be mixed into the stockpot 7. The angle of the slope of the blocking plate 14 relative to the horizontal direction, the size of the blocking plate 14, and the like are set in such a way that the condensate is not mixed into the stockpot 7.

Note that the blocking plate 14 also prevents oil of a motor (for driving a stirrer to be described later) accommodated in the holder 12 disposed above the blocking plate 14 from leaking out of the holder 12 and being mixed into the stockpot 7. In other words, the blocking plate 14 prevents mixing of a foreign substance into the stockpot 7.

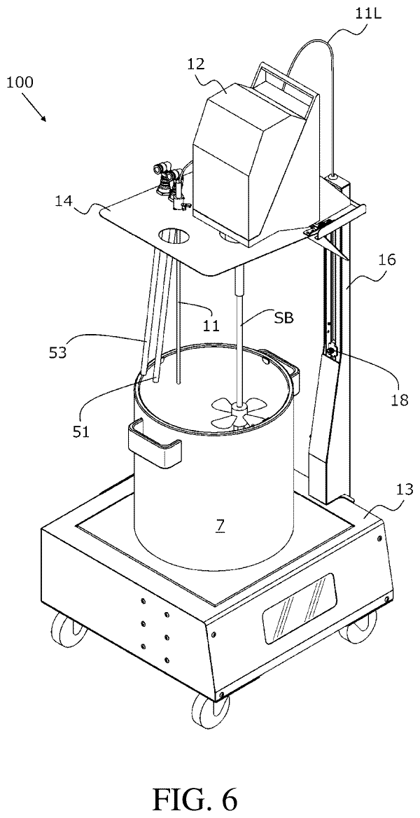

FIG. 6 is a perspective view of the apparatus 100. The figure illustrates a state in which the holder 12 is moved upward along the rail unit 16. For example, when replacing the stockpot 7 heated by the apparatus 100, a user moves the temperature sensor 11, the suction pipe 51, the return pipe 53, and a stirrer SB that are disposed inside the stockpot 7 out of the stockpot 7 and then takes out the stockpot 7 placed on the housing 13 from the apparatus 100. The stirrer SB includes a propeller blade disposed inside the stockpot 7 and stirring the soup reserved in the stockpot 7. The propeller blade is disposed at the lower end of the stirrer SB.

Herein, as described above, a user moves the positioning fixture 17 (unillustrated) upward and fixes the position of the positioning fixture 17 relative to the rail unit 16 by operating the positioning fixture 17 until the positioning fixture 17 abuts on the stopper 18 (unillustrated) disposed at the upper end of the rail unit 16. As a result, the temperature sensor 11, the suction pipe 51, the return pipe 53, and the stirrer SB that are disposed inside the stockpot 7 are retracted out of the stockpot 7. Subsequently, the user can take out the stockpot 7 from the apparatus 100 more easily.

As described above, a user installs a new stockpot 7 in the apparatus 100 (places a new stockpot 7 on the housing 13). Subsequently, the user moves the positioning fixture 17 downward and fixes the position of the positioning fixture 17 relative to the rail unit 16 by operating the positioning fixture 17 until the positioning fixture 17 abuts on the stopper 18 disposed at the lower end of the rail unit 16. As a result, the positions of the lower ends of the temperature sensor 11 and the suction pipe 51 are defined at predetermined positions inside the stockpot 7.

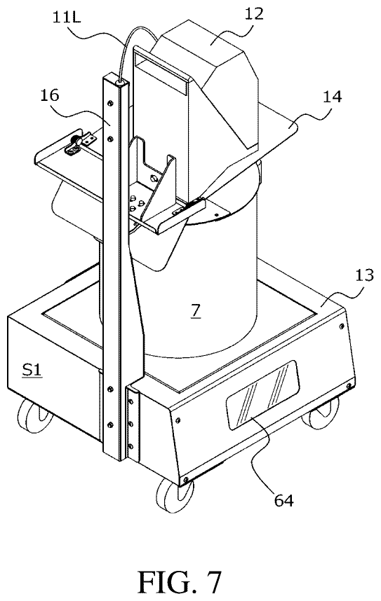

FIG. 7 is a perspective view of another embodiment of the supply apparatus according to the present invention. The figure illustrates that the rail unit 16 is attached to the first attachment location (P1, see FIG. 3) on the side surface S1 of the housing 13, as described above.

FIG. 8 is a schematic plan view of the housing 13 illustrating the attachment locations of the rail unit 16 on the housing 13.

The figure illustrates that the housing 13 includes a first surface S1 and a second surface S2, the first attachment location P1 is disposed on the first surface S1, and the second attachment location P2 is disposed on the second surface S2. The figure illustrates that the first attachment location P1 and the second attachment location P2 are disposed at opposing positions with respect to the disposed position of the heating unit 61 (the heating device 6) therebetween, as viewed from above the housing. Note that the first attachment location P1 and the second attachment location P2 are indicated by black circles in the figure for convenience of description.

The figure illustrates that the disposed position of the heating unit 61 (the heating device 6) in the housing is on a virtual line L3 connecting the first attachment location P1 to the second attachment location P2.

### Configurations of Seasoning Liquid Supply Apparatus and Temperature Measurement Device (2)

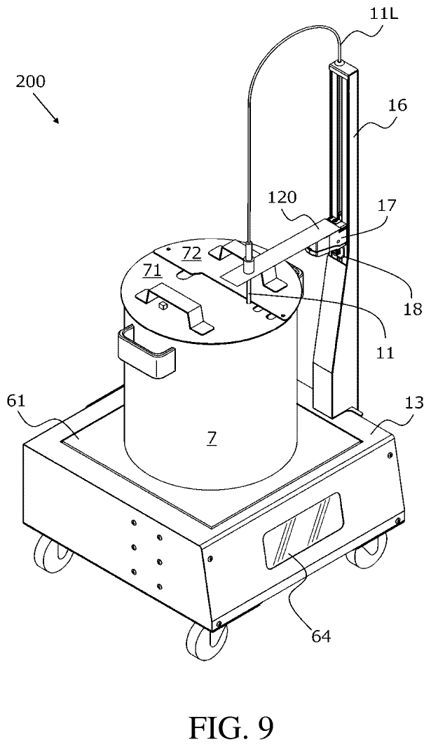

FIG. 9 is a perspective view of a seasoning liquid supply apparatus illustrating another embodiment of the seasoning liquid supply apparatus and the temperature measurement device according to the present invention.

A seasoning liquid supply apparatus 200 (hereinafter referred to as the “apparatus 200”) is an example of another embodiment of the seasoning liquid supply apparatus according to the present invention. The apparatus 200 differs from the apparatus 100 in that a holder 120 constituting the temperature measurement device differs from the holder 12 constituting the device 1.

The figure illustrates that the holder 120 holding a temperature sensor 11 is coupled with the positioning fixture 17. The figure illustrates that the holder 120 has a plate shape unlike the holder 12. The figure illustrates that the holder 120 holds only the temperature sensor 11. In other words, the holder 120 does not hold joints (the joints 51C and 53C in FIG. 3) constituting part of piping nor a stirrer (the stirrer SB in FIG. 6), unlike the aforementioned holder 12.

In this way, the seasoning liquid temperature measurement device according to the present invention may include a holder holding the temperature sensor 11 and allowing the temperature sensor 11 to move in and out between the inside and the outside of a stockpot 7 and a position adjustment unit allowing adjustment of the position of the temperature sensor 11 relative to the stockpot 7. The holder may or may not hold members other than the temperature sensor 11 (for example, the aforementioned joints and the stirrer).

### Conclusion

According to the embodiments described above, the position adjustment unit 15 is capable of defining the position of the temperature measurement unit in the temperature sensor 11 at a position with the highest temperature in the stockpot 7. The position of the temperature measurement unit in the temperature sensor 11 is defined at a desired position by moving the positioning fixture 17 downward by a user until the positioning fixture 17 abuts on the stopper 18. In other words, definition of the position of the temperature sensor 11 can be easily achieved.

Thus, the heating control unit 62 achieves the heating of the soup in the stockpot 7 in such a way that the temperature of the soup in the stockpot 7 converges to the target temperature without exceeding the upper temperature limit. As a result, the flow sensor 3 can measure an accurate flow rate. The temperature measurement unit in the temperature sensor 11 is disposed at the same height position as the suction port of the suction pipe 51 in the stockpot 7. In other words, the temperature sensor 11 measures a temperature close to the temperature, which is sucked by the suction pipe 51 and supplied to a bowl, among the soup reserved in the stockpot 7. Thus, the device 1 and the apparatuses 100 and 200 are capable of supplying a suitable volume of the soup reserved and heated in the stockpot 7 to a bowl at a suitable temperature.

By moving the positioning fixture 17 upward by a user until the positioning fixture 17 abuts on the stopper 18, the position of the temperature sensor 11 and/or the like disposed inside the stockpot 7 can be defined at a desired position, i.e., a position where the temperature sensor 11 and/or the like does not obstruct replacement of the stockpot 7. Thus, the device 1 and the apparatuses 100 and 200 offer ease of use for a user, such as for replacement of the stockpot 7 and cleaning of the device 1 and the apparatuses 100 and 200.

The temperature sensor 11 is disposed inside the stockpot 7 instead of outside the stockpot 7. By the temperature sensor 11 being disposed inside the stockpot 7, the temperature sensor 11 can directly measure the temperature of the soup reserved inside the stockpot 7. Assuming that the temperature sensor 11 is disposed outside the stockpot 7, a temperature measured by the temperature sensor 11 differs from the temperature of the soup reserved inside the stockpot 7. Specifically, responsiveness of measurement of the temperature of the soup by the temperature sensor 11 disposed inside the stockpot 7 is better than responsiveness of measurement of the temperature of the soup by the temperature sensor 11 disposed outside the stockpot 7. In other words, the precision of temperature control of the soup by the heating control unit 62 using the temperature sensor 11 disposed inside the stockpot 7 is higher than the precision of temperature control of the soup by the heating control unit 62 using the temperature sensor 11 disposed outside the stockpot 7.

### Features of Present Measurement Device and Present Supply Apparatus

Main features of the seasoning liquid temperature measurement and the seasoning liquid supply apparatus according to the present invention that are previously described are summarized below.

### Features of Seasoning Liquid Temperature Measurement Device

A seasoning liquid temperature measurement device according to the present invention is a device (for example, the device 100, 200) measuring the temperature of a seasoning liquid (for example, ramen soup) reserved and heated in a reserve tank (for example, the stockpot 7), the seasoning liquid temperature measurement device including: a temperature sensor (for example, the temperature sensor 11) disposed inside the reserve tank and measuring the temperature of the seasoning liquid reserved in the reserve tank; a holder (for example, the holder 12, 120) holding the temperature sensor; and a position adjustment unit (for example, the position adjustment unit 15) enabling adjustment of the position of the temperature sensor relative to the reserve tank.

In the seasoning liquid temperature measurement device according to the present invention, the position adjustment unit may include a rail unit (for example, the rail unit 16) moving the holder in such a way to allow the temperature sensor to move in and out between the inside and the outside of the reserve tank, and a positioning fixture (for example, the positioning fixture 17) fixing the position of the holder relative to the rail unit.

In the seasoning liquid temperature measurement device according to the present invention, the rail unit may include stoppers (for example, the stoppers 18) defining the position of the temperature sensor relative to the reserve tank.

The seasoning liquid temperature measurement device according to the present invention may include a housing (for example, the housing 13) to which the rail unit is attached, in which the housing may include attachment locations to which the rail unit is attached, and the attachment locations may include a first attachment location (for example, the first attachment location P1), and a second attachment location (for example, the second attachment location P2).

In the seasoning liquid temperature measurement device according to the present invention, the housing may accommodate a heating device (for example, the heating device 6) heating the seasoning liquid inside the reserve tank, and the first attachment location and the second attachment location may be disposed at opposing positions (for example, the first surface S1 and the second surface S2) with respect to the disposed position of the heating device therebetween, as viewed from above the housing.

In the seasoning liquid temperature measurement device according to the present invention, the disposed position of the heating device in the housing may be on a virtual line (for example, the virtual line L3) connecting the first attachment location to the second attachment location.

The seasoning liquid temperature measurement device according to the present invention may include a blocking plate (for example, the blocking plate 14) disposed above the reserve tank, in which, when the temperature sensor is disposed inside the reserve tank, the blocking plate may be obliquely disposed relative to the horizontal direction.

In the seasoning liquid temperature measurement device according to the present invention, when the temperature sensor is disposed inside the reserve tank, the holder may be disposed above the blocking plate, and the temperature sensor may be disposed below the blocking plate.

In the seasoning liquid temperature measurement device according to the present invention, the blocking plate may include a hole (for example, the hole 14h) in which a funnel, through which a replenishment liquid to be replenished to the reserve tank passes, is disposed.

### Features of Seasoning Liquid Supply Apparatus

A seasoning liquid supply apparatus according to the present invention is an apparatus for supplying a seasoning liquid (for example, soup) included in a food and drink product (for example, ramen) to a container (for example, the bowl 8) in which the food and drink product is accommodated, the supply apparatus including: a liquid feeding unit (for example, the liquid feeding unit 2) feeding the seasoning liquid from a reserve tank (for example, the stockpot 7) in which the seasoning liquid is reserved to the container; a flow sensor (for example, the flow sensor 3) measuring a flow rate of the seasoning to be fed from the reserve tank to the container; a supply control unit (for example, the supply control unit 4) controlling supply of the seasoning liquid from the reserve tank to the container, based on the flow rate measured by the flow sensor; a heating device (for example, the heating device 6) heating the seasoning liquid reserved in the reserve tank; and a temperature measurement device (for example, the device 1) measuring the temperature of the seasoning liquid reserved in the reserve tank, in which the temperature measurement device is the seasoning liquid temperature measurement device according to the present invention.

In the seasoning liquid supply apparatus according to the present invention, the heating device may include: a heating unit (for example, the heating unit 61) heating the seasoning liquid reserved in the reserve tank; and a heating control unit (for example, heating control unit 62) controlling heating output of the heating unit, and the heating control unit may control the heating output, based on a change in the temperature measured by the temperature measurement device.

In the seasoning liquid supply apparatus according to the present invention, the heating device may include a storage (for example, the storage 63) storing a target temperature (for example, 95 °C) of the seasoning liquid reserved in the reserve tank, the target temperature is lower than a boiling point of the seasoning liquid, and the heating control unit may control the heating output in such a way that the temperature measured by the temperature measurement device converges to the target temperature.

In the seasoning liquid supply apparatus according to the present invention, the heating unit may heat the outside of a bottom portion (for example, the bottom surface 7B of the stockpot 7) of the reserve tank, and the height position of a temperature measurement unit of the temperature sensor inside the reserve tank may be in proximity to the inner side of the bottom portion of the reserve tank.

The seasoning liquid supply apparatus according to the present invention may include piping (for example, the piping 5) through which the seasoning liquid reserved in the reserve tank passes, in which one end of the piping is disposed inside the reserve tank, and the height position of the one end inside the reserve tank may be almost equal to the height position of the temperature sensor inside the reserve tank.

In the seasoning liquid supply apparatus according to the present invention, the piping may include: a suction pipe (for example, the suction pipe 51) disposed on the reserve tank side; a discharge pipe (for example, the discharge pipe 52) disposed on the container side; and a valve (for example, the valve 54) disposed between the suction pipe and the discharge pipe, and the supply control unit may control supply of the seasoning liquid from the reserve tank to the container by controlling opening and closing of the valve.

### REFERENCE SIGNS LIST

1 Seasoning liquid temperature measurement device
11 Temperature sensor
12 Holder
13 Housing
14 Blocking plate
15 Position adjustment unit
16 Rail unit
17 Positioning fixture
18 Stopper
2 Liquid feeding unit
3 Flow sensor
4 Supply control unit
5 Piping
51 Suction pipe
52 Discharge pipe
53 Return pipe
54 Valve
6 Heating device
61 Heating unit
62 Heating control unit
63 Storage unit
64 Control Panel
7 Reserve tank
8 Container
100 Seasoning liquid supply apparatus
200 Seasoning liquid supply apparatus

1. A seasoning liquid temperature measurement device for measuring temperature of a seasoning liquid reserved and heated in a reserve tank, the temperature measurement device comprising:
a temperature sensor configured to be disposed inside the reserve tank and configured to measure temperature of the seasoning liquid reserved in the reserve tank;
a holder configured to hold the temperature sensor; and
a position adjustment unit configured to enable adjustment of a position of the temperature sensor relative to the reserve tank.

2. The seasoning liquid temperature measurement device according to claim 1, wherein the position adjustment unit includes:
a rail unit configured to move the holder in such a way to allow the temperature sensor to move in and out between the inside and the outside of the reserve tank; and
a positioning fixture configured to fix a position of the holder relative to the rail unit.

3. The seasoning liquid temperature measurement device according to claim 2, wherein the rail unit includes stoppers configured to define a position of the temperature sensor relative to the reserve tank.

4. The seasoning liquid temperature measurement device according to claim 3, further comprising a housing to which the rail unit is attached, wherein
the housing includes attachment locations to which the rail unit is attached, and the attachment locations include:
a first attachment location; and
a second attachment location.

5. The seasoning liquid temperature measurement device according to claim 4, wherein
the housing accommodates a heating device configured to heat the seasoning liquid inside the reserve tank, and
the first attachment location and the second attachment location are disposed at opposing positions with respect to a disposed position of the heating device between the first attachment location and the second attachment location, as viewed from above the housing.

6. The seasoning liquid temperature measurement device according to claim 5, wherein the disposed position of the heating device in the housing is on a virtual line connecting the first attachment location to the second attachment location.

7. The seasoning liquid temperature measurement device according to claim 1, further comprising a blocking plate configured to be disposed above the reserve tank, wherein,
when the temperature sensor is disposed inside the reserve tank, the blocking plate is obliquely disposed relative to a horizontal direction.

8. The seasoning liquid temperature measurement device according to claim 7, wherein,
when the temperature sensor is disposed inside the reserve tank, the holder is disposed above the blocking plate, and
the temperature sensor is disposed below the blocking plate.

9. The seasoning liquid temperature measurement device according to claim 8, wherein the blocking plate includes a hole in which a funnel, through which a replenishment liquid to be replenished to the reserve tank passes, is disposed.

10. A seasoning liquid supply apparatus for supplying a seasoning liquid included in a food and drink product to a container in which the food and drink product is accommodated, the supply apparatus comprising:
a liquid feeding unit configured to feed the seasoning liquid from a reserve tank in which the seasoning liquid is reserved to the container;
a flow sensor configured to measure a flow rate of the seasoning to be fed from the reserve tank to the container;
a supply control unit configured to control supply of the seasoning liquid from the reserve tank to the container, based on the flow rate measured by the flow sensor;
a heating device configured to heat the seasoning liquid reserved in the reserve tank; and
a temperature measurement device configured to measure temperature of the seasoning liquid reserved in the reserve tank, wherein
the temperature measurement device is the seasoning liquid temperature measurement device according to claim 1.

11. The seasoning liquid supply apparatus according to claim 10, wherein
the heating device includes:
a heating unit configured to heat the seasoning liquid reserved in the reserve tank; and
a heating control unit configured to control heating output of the heating unit, and
the heating control unit controls the heating output, based on a change in the temperature measured by the temperature measurement device.

12. The seasoning liquid supply apparatus according to claim 11, wherein
the heating device includes a storage configured to store a target temperature of the seasoning liquid reserved in the reserve tank, wherein
the target temperature is lower than a boiling point of the seasoning liquid, and
the heating control unit controls the heating output in such a way that the temperature measured by the temperature measurement device converges to the target temperature.

13. The seasoning liquid supply apparatus according to claim 10, wherein
the heating unit heats an outside of a bottom portion of the reserve tank, and
a height position of a temperature measurement unit of the temperature sensor inside the reserve tank is in proximity to an inner side of the bottom portion of the reserve tank.

14. The seasoning liquid supply apparatus according to claim 13, further comprising piping through which the seasoning liquid reserved in the reserve tank passes, wherein
one end of the piping is disposed inside the reserve tank, and
a height position of the one end inside the reserve tank is almost equal to a height position of the temperature sensor inside the reserve tank.

15. The seasoning liquid supply apparatus according to claim 14, wherein
the piping includes:
a suction pipe configured to be disposed on the reserve tank side;
a discharge pipe configured to be disposed on the container side; and
a valve configured to be disposed between the suction pipe and the discharge pipe, and
the supply control unit controls supply of the seasoning liquid from the reserve tank to the container by controlling opening and closing of the valve.
